(19) United States
(12) Patent Application Publication
(10) Pub. No.: US 2003/0009358 A1
(43) Pub. Date: Jan. 9, 2003

(54) Bankruptcy insurance product and method for implementing same

(76) Inventors: Samuel L. Greenfeld, Harlingen, TX (US); John Ventura, South Padre Island, TX (US); Lonnie B. Davis, Harlingen, TX (US)

Correspondence Address: ROBERT W. STROZIER, SUITE 930, 2925 BRIANPARK DRIVE, HOUSTON, TX, 77042, US

(21) Appl. No.: 10/036,102

(22) Filed: Nov. 7, 2001

Related U.S. Application Data
(60) Provisional application No. 60/246,412, filed on Nov. 7, 2000.

(51) Int. Cl. G06F 17/60

(52) U.S. Cl. 705/4

(57) ABSTRACT

An insurance product and business method incorporating the product is disclosed. The product is designed to be coupled to a court ordered or administered payment or repayment plan, where the product includes at least a life insurance component, an unemployment component, and a disability component where the benefits of each component, once activated, are paid to a person or agency administering the plan. Once the plan is complete, the insurance product would terminate. Premiums, which are bundled into the plan payments, can either be fixed, variable, or scaled. The insurance product and business method is ideally suited for use in Chapter 13 Reorganization Plans administered by a court and overseen by a bankruptcy trustee.

### RELATED APPLICATIONS

This application claims provisional priority to U.S. Provisional Patent Application Serial No. 60/246,412 filed Nov. 7, 2000.

### BACKGROUND OF THE INVENTION

1. Field of the Invention

The present invention relates to an insurance product and business method for plans established under Chapter 13 of the United States Bankruptcy laws.

More particularly, the present invention relates to an insurance product and business method where the insurance product insures all or some of payments associated with a court ordered payment according to a court ordered schedules such payments and a payment schedule established under a Chapter 13 Bankruptcy plan for the repayment of debt. The business method relates to the product format, product options, manner of implementation and manner of monitoring. The method and product also include cost and penalty schedules.

2. Description of the Related Art

Currently, United States Bankruptcy laws provide debtors with protection from their creditors. There are two primary alternatives available for personal bankruptcy. The individual may completely liquidate debts under the rules set forth in Chapter 7 of the bankruptcy code or establish a repayment plan under the rules set forth in Chapter 13 of the bankruptcy code.

Chapter 13 allows a qualified debtor relief from creditors by establishing a reorganization plan obligating the debtor to repay a specified total amount of indebtedness to priority, secured and unsecured creditors in equal, monthly payments for a specified term; although, in a small number of cases the payment can be variable. The term established under Chapter 13 plans generally ranges between 36 and 60 months depending on debtor's ability to repay and the total indebtedness that exists.

The Chapter 13 reorganization plan is prepared by an attorney; a court approves the plan; and a Trustee administers it. Once the Chapter 13 reorganization plan is approved, the Trustee's role is to receive the debtor's monthly payment and disperse it among the priority, secured and unsecured creditors as outlined in the plan.

Chapter 13 reorganization plans allow a debtor relief and gives the debtor the opportunity to reestablish financial well being. It protects personal property and personal assets such as a debtor's home and automobile from being seized by creditors. Creditors naturally prefer Chapter 13 plans over Chapter 7 plans, because the creditors will receive payment albeit a lesser amount.

Many factors prevent a debtor from completing an established Chapter 13 Reorganization Plan. Consequences of an uncompleted plan may include forfeiture of property and Chapter 7 liquidation. Uncompleted plans cost the debtor as well as the creditor and create added expense to the Bankruptcy courts. If a debtor cannot make the prescribed monthly payments, the debtor may ask the court to modify the plan. Many times, however, there is a reason why a debtor is unable to make payments. If the debtor is sick or hurt, the debtor may be unable to work. Generally, this will lead to a disruption of income and the debtor's failure to complete the Chapter 13 Reorganization Plan.

Many employers experience financial problems which lead to bankruptcy, temporary lay offs, cut backs and lost contracts. A debtor who loses employment through no fault of the debtor will not have the income required to support the Chapter 13 Reorganization Plan payments. These circumstances most often lead to another Chapter 13 plan failure. Most debtors who die while making payments under a Chapter 13 Reorganization Plan leave their family without means to continue making plan payments to the Trustee. Once again, a failed Chapter 13 Reorganization Plan is the likely outcome.

A plan of insurance protecting the debtor and co-debtor against specific perils would help create an environment leading to a greater percentage of completed plans. Thus, there is a need in the art for an insurance product and a method for structuring an insurance product that would increase completion of Chapter 13 Reorganization Plan.

### SUMMARY OF THE INVENTION

The present invention provides a method for improving the completion rate of Plans including Chapter 13 Reorganization Plans, child support payment plans, alimony payment plans or other plans overseen by a court of other judicial or quasi-judicial body. Generally, the method would include the steps of first establishing a plan during which payments are due and payable to a court or court appointed agent such as a trustee for a given period of time according to a given time schedule which may be fixed (e.g., monthly) or variable. Associating an insurance product with the plan to insure scheduled payments, if the payor dies, becomes disabled, or becomes involuntarily unemployed. The insurance product would make the payments for the debtor to the court or court appointed agent upon death, during a period of disability or during a period of involuntary unemployment

In the case of a Chapter 13 Reorganization Plan, the method would include the steps of establishing a Chapter 13 Reorganization Plan. The Plan details a debt amount covered by the plan, a term in month for repaying the debt and a schedule for repaying the amount during the term, where the schedule includes equal monthly payments having a payment amount equal to the debt amount divided by the term of the plan in months or variable payment in timing and/or amount. Once the Chapter 13 Reorganization Plan is established, an insurance product is added that provides for plan for assistance towards plan completion, if the debtor dies or if the debtor becomes unemployed through no fault of the debtor and/or becomes disabled during any part of the term of the plan. When the plan is completed, the insurance product terminates. If the debtor or co-debtor dies during the term of the plan, the remaining balance owed is paid to the Trustee for disbursement to applicable creditors.

If the debtor becomes disabled through an accident or illness, and is under a doctor's care and cannot work or if the debtor becomes involuntarily unemployed during the term of the plan and prior to its completion, the debtor becomes eligible (after a period of consecutive days of disability or unemployment, generally 30 days) to receive the disability or unemployment benefits of the product. After the time period of consecutive days, benefits will be paid retroactively to the first day of disability or unemployment. Once of debtor becomes involuntarily unemployed and the benefits are being received, the product preferably also includes a provision requiring the debtor to show evidence of a good faith attempt to regain employment. Such evidence can include, without limitation, registration of the debtor with a recognized employment service or agency. For example, in Texas, a good faith attempt to regain employment may be fulfilled by the debtor registering with the Texas Workforce Commission or a reputable public or private employment service or agency. Scheduled payments will be paid, up to policy maximum, while the debtor remains disabled or involuntarily unemployed. Such payments are preferably made directly to the Trustee on behalf of the debtor for disbursement among applicable creditors.

Preferably, in the case of Chapter 13 Reorganization Plan, the payment would be equal monthly payment.

The present invention provides an insurance product for improving the completion of any judicial or quasi-judicial plan involving a schedule of fixed or variable payments including Chapter 13 Reorganization Plans, Child Support Plans, Alimony Plans, Settlement Plans or the like. Generally, the product includes provisions to insure scheduled payments if the payor is unable to make payments, provided, however, that the payor's inability is a covered inability. Such inabilities can includes, without limitation, death, insolvency, disability, involuntary unemployment, or other temporary or permanent allowable inabilities to make one or more scheduled payments. Of course, the insurance product would generally include provisions that the payor would have to meed in order to invoke the insurance benefits.

In the case of Chapter 13 Reorganization Plans, the product includes a life insurance component, a disability component and an unemployment component. The insurance product also includes a provision for creditor bundling so that funds from the insurance product once activated are distributed according to the Trustee according to the Chapter 13 Reorganization Plan.

Creditor bundling is a unique aspect of this invention. By naming the Chapter 13 Trustee as the beneficiary of the insurance component's benefits, the product assures multiple creditors of relief under the provisions of the insurance product. All eligible creditors, regardless of the number, under the provisions outlined in the Chapter 13 Reorganization Plan, would be satisfied through the benefits of a single insurance product. Creditor bundling provides more protection at an affordable rate than separating creditors and providing protection from numerous policies and numerous insurance carriers.

The present invention also provides a method for improving the completion rate of a court ordered payment plans including the steps of: (a) establishing a plan to be overseen by a court or other judicial or quasi-judicial body, where the plan includes: (i) a clearly identifiable payor and at least one clearly identifiable payee; (ii) a debt amount to be covered by the plan; (iii) a term in month for paying the debt amount; and (iv) a schedule of debt payments designed to repay the debt amount during the term; (b) coupling an insurance product with the plan, where the product includes: (i) a life insurance component, which provides funds in case of a payor's death during the term of the plan to repay an outstanding debt amount; (ii) a disability component, which provided funds in case of a payor's disability during the term of the plan to repay an outstanding debt amount; (iii) an unemployment component, which provided funds in case of a payor's unemployment during the term of the plan to repay an outstanding debt amount; and (iv) a premium. The method can further include the step of: (c) terminating the insurance product, when the plan is complete.

Preferably, the unemployment component activates only if the payor becomes unemployed through no fault of the payor during the term of the plan. Preferably the product further includes a creditor bundling provision, where benefits under the insurance components are paid directly to a person or agency overseeing the plan to ensure that proceeds of each component are disbursed to all qualified creditors of the payor. Preferably, the premium comprise a single product payment or a plurality of product payments having the same or different product payment amount during the term of the plan. Preferably, the product payments comprise equal monthly payments, or the product payments start at an initial amount and decrease at a rate proportional to the outstanding debt amount, or the product payments start at an initial amount and increase at a rate proportional to the outstanding debt amount.

The present invention also provides a method for improving the completion rate of Chapter 13 Bankruptcy Reorganization Plan including the steps of: (a) establishing a Chapter 13 Bankruptcy Reorganization Plan including: (i) a clearly identifiable debtor and at least one clearly identifiable creditor; (ii) a debt amount to be covered by the plan; (iii) a term in months for repaying the debt amount; and (iv) a schedule of debt payments designed to repay the debt amount during the term; (b) issuing an insurance product with the plan, where the product includes: (i) a life insurance component, which provides funds in case of a debtor's death during the term of the plan to repay an outstanding debt amount; (ii) a disability component, which provided funds in case of a debtor's disability during the term of the plan to repay an outstanding debt amount; (iii) an unemployment component, which provided funds in case of a debtor's unemployment during the term of the plan to repay an outstanding debt amount; and (iv) a premium; and (c) terminating the insurance product, when the plan is complete.

Preferably, the unemployment component activates only if the debtor becomes unemployed through no fault of the debtor during the term of the plan. Preferably, the product further includes a creditor bundling provision, where benefits under the insurance components are paid directly to a person overseeing the plan to ensure that proceeds of each component are disbursed to all qualified creditors of the debtor. Preferably, the premium comprise a single product payment or a plurality of product payments having the same or different product payment amount during the term of the plan. Preferably, the product payments comprise equal monthly payments, or the product payments start at an initial amount and decrease at a rate proportional to the outstanding debt amount, or the product payments start at an initial amount and increase at a rate proportional to the outstanding debt amount.

The present invention also provides a method for completing a Chapter 13 Reorganization Plan including the steps of: (a) establishing a Chapter 13 Reorganization Plan including: (i) a clearly identifiable debtor and at least one clearly identifiable creditor; (ii) a total amount of debt covered by the plan; (ii) a term in months for repaying the debt amount; and (iii) a schedule of debt payments designed to repay the debt amount during the term; (b) issuing an insurance product including: (i) a life insurance component; (ii) a disability component; (iii) an unemployment component; and (iv) a premium; (c) activating the life insurance component of the product, if the debtor dies during the term of the plan; (d) activating the unemployment component of the product, if the debtor becomes unemployed during the term of the plan, until the debtor becomes re-employed and able to resume plan payments or the plan is completed; (e) activating the disability component of the product, if the debtor becomes disabled during the term of the plan until the debtor becomes enabled, re-employed and able to resume plan payments or the plan is completed; and (f) terminating the product, if and when the plan is completed.

Preferably, the unemployment component activates only if the debtor becomes unemployed through no fault of the debtor. Preferably, the product also includes a creditor bundling provision designed to insure that proceeds of the product are used as if the payment was coming directly from the debtor. Preferably, the premium comprise a single product payment or a plurality of product payments having the same or different product payment amount during the term of the plan. Preferably, the product payments comprise equal monthly payments, or, the product payments start at an initial amount and decrease at a rate proportional to the outstanding debt amount, or the product payments start at an initial amount and increase at a rate proportional to the outstanding debt amount.

The present invention also provides an insurance system for improving the completion of Chapter 13 Bankruptcy Reorganization Plan comprising a chapter 13 reorganization plan including a total indebtedness, a term for repayment and a schedule of periodic payments and an insurance product including a life insurance component, a disability component and an unemployment component and a provision for creditor bundling so that funds from the insurance product once activated are distributed according to the Chapter 13 Bankruptcy Reorganization Plan.

### DESCRIPTION OF THE DRAWINGS

The invention can be better understood with reference to the following detailed description together with the appended illustrative drawings in which like elements are numbered the same:

FIG. 1A depicts a block diagram illustrating a preferred embodiment of the method of this inventions;

FIG. 1B depicts a block diagram illustrating a preferred embodiment for the disability validity test of FIG. 1A;

FIG. 1C depicts a block diagram illustrating a preferred embodiment for the unemployment validity test of FIG. 1A;

FIG. 2A depicts a block diagram illustrating a preferred insurance product payment schedule for the insurance products of the present invention; and

FIG. 2B depicts a block diagram illustrating a preferred insurance product payment schedule for the insurance products of the present invention;

### DETAILED DESCRIPTION OF THE INVENTION

The inventors have found that a method and a product can be constructed that improves the completion rate of court ordered payment plans including Chapter 13 Reorganization Plans, by coupling a tailored insurance product to the plan, the benefits of which would provide for plan payments to be made if the debtors becomes disabled or involuntarily unemployed during the term of the Chapter 13 Reorganization Plan. In addition, the remaining balance would be paid if the debtor or co-debtor dies prior to completion of the Plan, which would result in plan completion. This same product can also be adapted for use with other court imposed payment schedules such as alimony, child support or care or the like, where a clear debtor/creditor or payor/payee relationship is present or exists. A clear debtor/creditor or payor/payee relationship assures that a insurance product can be clearly written to insure such court imposed payment schedules. Such products allow courts or other quasi-judicial bodies such as the EPA, FDA or the like, more flexibility in designing or structuring payment schedules such as alimony or support payment schedules. Credit bundling would be implemented where applicable. Coupling an insurance product of this invention with any of these court ordered remedies would afford the court greater flexibility and reduce non-payment of the remedy because a non-governmental agency would also have a stake in insuring that the remedy was properly executed or completed.

Generally, the Chapter 13 Reorganization Plan insurance product includes three basic components: 1) a life insurance component; 2) a disability insurance component; and 3) an unemployment insurance component. Although the product and each basic component can include provisions not related to the Chapter 13 Reorganization Plan, the product and each component are generally limited in amount to the total amount of indebtedness included in the Chapter 13 Reorganization Plan.

A sample Chapter 13 Reorganization Plan is shown herein as Appendix A.

The life insurance component is of course a death benefit that would be afforded to either the debtor or co-debtor in the amount of the total indebtedness as of the date of death, up to a maximum policy limit which may or may not be the same as the total remaining indebtedness. The benefits of the life insurance component would be paid directly to the Trustee for disbursement among the applicable creditors, resulting in the termination of the insurance product under the Chapter 13 Reorganization Plan and completion of the Plan itself. In certain states, the co-debtor must be a spouse and be jointly liable for repayment of the indebtedness established by the Chapter 13 Reorganization Plan. Exact insurance product provisions will generally be state of the art standard provisions used in the industry.

Disability and unemployment components of the product are designed to insure Chapter 13 Reorganization Plan completion if the debtors becomes disabled through an accident or illness, and is under the care of a health care provider and cannot work, or becomes involuntarily unemployed, the insurance product of the present invention will make the scheduled monthly payments, up to the master policy maximum, while the debtor remains disabled or involuntarily unemployed. Exact policy provisions will be governed by the insuring company as is well known in the art.

The insurance product of this invention also provides creditor protection on a bundled creditor basis. A Chapter 13 Reorganization Plan establishes a legal relationship between the debtor and the debtor's creditors. Since the Trustee represents numerous creditors, the Trustee becomes the vehicle for payment of proceeds from the insuring company to the creditors for qualifying claims incurred by the debtor named in the Chapter 13 Reorganization Plan.

General provisions of the insurance product or policy will be subject to the insuring company and prevailing laws of each state. The monthly premium rate will be determined by the insuring company and can be fixed, variable or scaled and are preferably part of the month payment amount made to the trustee. Rates can and will vary on a state-by-state basis and on a insurer-by-insurer basis. Preferably, the premium is between about $0.90 per $100 of coverage and about $0.10 per $100 of coverage, particularly, between about $0.80 per $100 of coverage and about $0.20 per $100 of coverage and especially between about $0.60 per $100 of coverage and about $0.20 per $100 of coverage.

Generally, the monthly premium is calculated for each Chapter 13 Reorganization Plan by taking the total outstanding balance and multiplying it by the premium rate set for the product. This total premium figure is then divided by the total number of months in the term of the Plan. The resulting amount if the applicable premium for each month of the term until plan completion or termination. Although a flat premium is preferred, the monthly premium can be variable or ramp up or ramp down. Thus, the monthly premium could start out low and escalate, start high and decrease, or be indexed to the outstanding balance under the Chapter 13 Reorganization Plan.

A model insurance product Summary of Insurance Coverages is shown herein as Appendix B, which describes the provisions that correspond to a preferred embodiment of the insurance products of this invention.

The most advantageous method for marketing this product is on a direct distribution basis. Attorneys preparing Chapter 13 Reorganization Plans will market the product to their clients. Each writing attorney must be appointed with the insuring company and be properly licensed with the state in which the attorney is conducting business. In Texas, for example, the attorney would require a Group II license issued by the Texas Department of Insurance. The attorney would be appointed with the insuring company and must follow rules and regulations established by the Department of Insurance and the insuring company.

Debtor and co-debtor must sign an application of the product. The insurance enrollment identifies the limitations, exclusions, and cost disclosures inherent in the group credit insurance program. Another unique feature in this invention is the role of the attorney. The attorney must disclose in the application that the attorney's role as an attorney is met in the preparation of the Chapter 13 Reorganization Plan. The attorney must make it clear that the attorney is not representing the debtor and co-debtor in an official capacity as their attorney when offering the insurance product. The fact that the attorney is also offering the insurance product.

As a writing agent for the insurer, the attorney will receive a commission as expressed by a percentage of collected premium for the attorney's marketing of the product.

Coverage, as described herein, is not currently offered to debtors and co-debtors in Chapter 13 Reorganization Plans. Obviously, the need exists. Coverage would serve to reduce the growing number of plan failures and decrease the likelihood that debtor's property would require liquidation if the Chapter 13 Reorganization Plan fails. Creditors would be more apt to see plans completed which would limit their losses and increase revenue. Utilizing the concept set forth above, an entire group of creditors can be served through one beneficiary of benefits of the coupled insurance product, the Trustee. The Trustee disperses payments to the creditors as well as the benefits from the insuring company for any claim event. As the attorney preparing the Chapter 13 Reorganization Plan, the attorney is best qualified and in the most advantageous position to offer and explain the broad benefits afforded by this type of product.

Although the methods of the present invention are not in the nature of computer software, a conceptual flow chart is instructive and illustrative of the way in which the method and the insurance product operate to increase the rate of plan completion. The following block diagrams illustrate the method and the insurance product in at Chapter 13 Reorganization Plan context and are included for illustration and not limitation. The basic block diagrams used in the Chapter 13 Reorganization Plan embodiment set forth below are readily transferable to Child support, Alimony support, or any of Plan that has identifiable payors and identifiable payees and is administered through court or other quasi-judicial oversight.

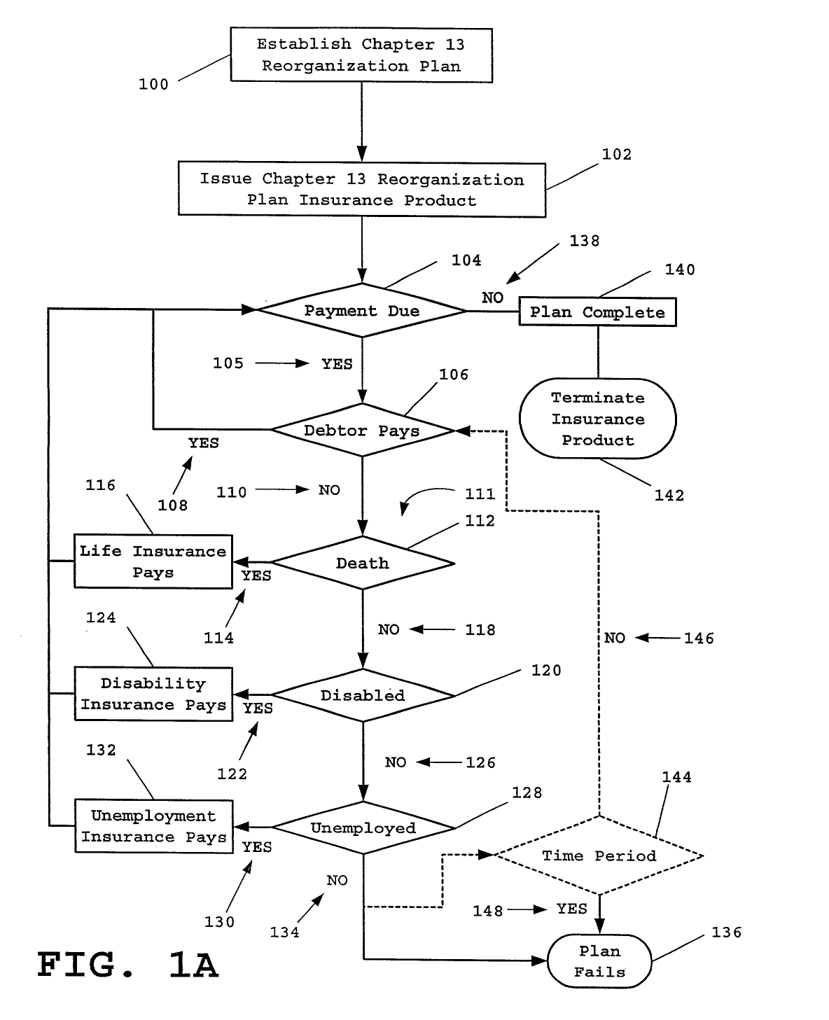

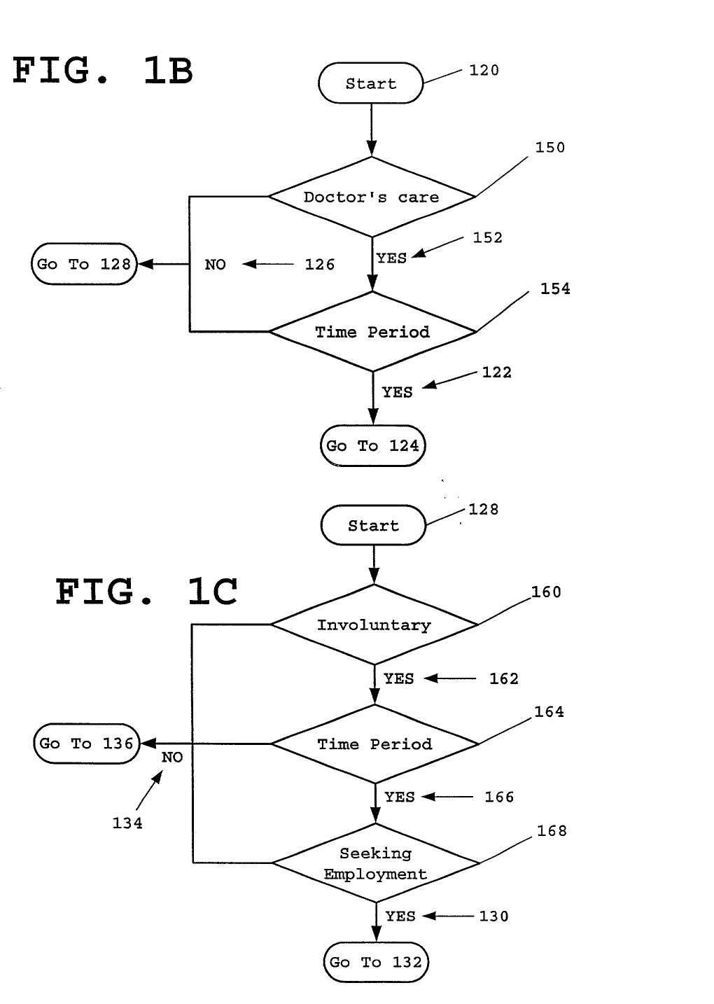

Referring now to FIGS. 1A-C, a block diagram of a preferred embodiment of a method for improving Chapter 13 Reorganization Plans completion rates is shown to include a step 100, wherein a Chapter 13 Reorganization Plan is established by a bankruptcy court for an eligible debtor. Once the plan is established, a Chapter 13 Reorganization Plan insurance product is issued in an issue insurance step 102. When the plan is established, a schedule of payments is also established, which is represented by a conditional payment due step 104. If payments are still due under the plan, then control is transferred along a YES branch 105 to a debtor pay conditional step 106. If the debtor makes the payment, then control is simply transferred along a YES branch 108 back to the payment due step 104, where the next payment will again invoke the conditional step 106. If the debtor is unable to pay, then control is transferred along a NO branch 110 to a series of conditional step 111. The series of conditional steps 111 includes at least the three claim activation events in the preferred Chapter 13 Reorganization Plan insurance product; death, disability and unemployment. Although FIG. 1 shows the three insurance product activation steps in a specific order, no preferred order is intended, in fact, a single compound conditional branching step could have been used as well.

The series of conditional steps 111 includes a death test step 112. If the debtor or co-debtor is dead, then control is transferred along a YES branch 114 to a life insurance pays step 116 and back to the payment due step 104.

If the debtor is not dead, then control is transferred along a NO branch 118 to a disabled test step 120.

If the debtor is disabled, then control is transferred along a YES branch 122 to a disability insurance pays step 124 and back to the payment due step 104. If the debtor is not disabled, then control is transferred along a NO branch 126 to an unemployed test step 128.

If the debtor is unemployed, then control is transferred along a YES branch 130 to an unemployment insurance pays step 132 and back to the payment due step 104. If the debtor is not unemployed, then control is transferred along a NO branch 134 to a plan fails termination step 136.

Going back to the conditional payment due step 104, if no more payments are due, then control is along a NO branch 138 to a completion of plan step 140 and then to a termination of the insurance product step 142.

If the disability and/or unemployment tests steps 120 and 128 have time period of either disability or unemployment prior to qualification for the benefits, then the NO branch 134 can proceed to a time period conditional step 144. If the time period has not been satisfied, then control is transferred along a NO branch 146 to the payment due step 104; otherwise, control is transferreda along a YES branch 148 to plan fails step 136.

Referring now to FIGS. 1B, a preferred embodiment for the disabled test step 120 is shown to include a doctor's care test step 150. If the debtor is in the care of a doctor or other health care provider who can validate the disability, then control is transferred along the YES branch 152 to a time period test step 154. If the debtor is not in the care of a doctor or other health care provider, then control is transferred along the NO branch 126 to the conditional test step 128. If the debtor has been disabled for the period of time set in the insurance product, then control is transferred along the YES branch 122 to the pay step 124; otherwise control is transferred along the NO branch 126 to the conditional step 128.

Referring now to FIGS. 1C, a preferred embodiment for the unemployment test step 128 is shown to include an involuntary unemployment test step 160. If the debtor was involuntarily unemployed, through no fault of the debtor, then control is transferred along the YES branch 162 to a time period test step 164. If the debtor was not involuntarily unemployed through no fault of the debtor, then control is transferred along the NO branch 134 to the conditional test step 132. If the debtor has been unemployed for the period of time set in the insurance product, then control is transferred along the YES branch 166 to a seeking employment test step 168. If the debtor is seeking employment in an acceptable manner as set forth in the insurance product, then control is transferred along the YES branch 130 to the pay step 132; otherwise control is transferred along the NO branch 130 to the plan fails step 132.

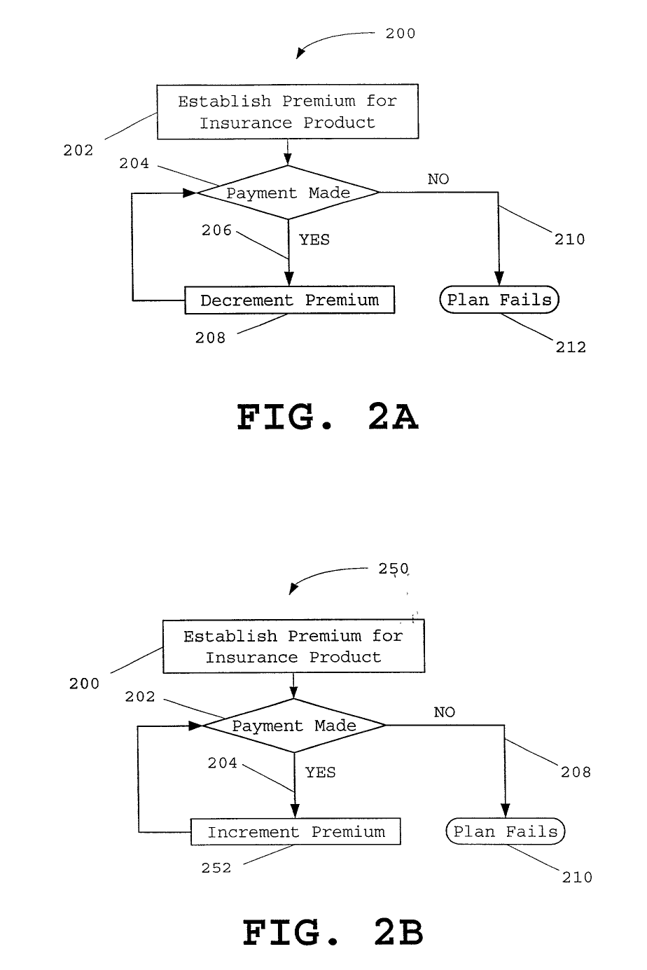

Although the preferred premium is a fixed premium, scaled premiums can be used as well. FIGS. 2A and B illustrate two alternate embodiments for setting insurance premiums, generally 200 and 250. Additionally, more complex premium formulas can be used as well. Looking at FIG. 2A, the premium modification procedure 200 include an establish initial premium step 202. Once the initial premium is set, a conditional payment made step 204 is invoked. If the payment is made, then control is transferred along a YES branch 206 to an decrement premium step 208 and back to the conditional payment made test step 204. Preferably, the decrement is proportional to total amount of unpaid debt. Thus, the premium would be indexed to the total indebtedness, which would decrease as each payment is made. The decrement can be directly proportional decrease, i.e., the dollar amount of the premium is reduced by the fractional amount of the payment relative to the remaining outstanding indebtedness−premium=premium−premium*(payment/remaining indebtedness). Of course, the decrement in premium can be any agreed upon formula, which can allow the premium to decrease faster or slower than the pay down rate of the plan itself. If the payment is not made at the conditional step 204, then control is transferred along a NO branch 210 to a plan fails termination step 212. If a person fails to pay

Looking at FIG. 2B, the premium modification procedure 250 include the establish initial premium step 202. Once the initial premium is set, the conditional payment made step 204 is invoked. If the payment is made, then control is transferred along the YES branch 206 to an increment premium step 252 and back to the conditional payment made test step 204. Preferably, the increment is proportional to total amount of unpaid debt. Thus, the premium would be indexed to the total indebtedness, which would decrease as each payment is made, while the premium would increase as each payment is made. The increment can be directly proportional decrease, i.e., the dollar amount of the premium is increased by the fractional amount of the payment relative to the remaining outstanding indebtedness−premium=premium+premium*(payment/remaining indebtedness). Of course, the increment in premium can be any agreed upon formula, which can allow the premium to increase faster or slower than the pay down rate of the plan itself. If the payment is not made at the conditional step 204, then control is transferred along a NO branch 210 to a plan fails termination step 212.

[image]

[image]

[image]

[image]

[image]

[image]

[image]

[image]

[image]

All references cited herein are incorporated by reference. While this invention has been described fully and completely, it should be understood that, within the scope of the appended claims, the invention may be practiced otherwise than as specifically described. Although the invention has been disclosed with reference to its preferred embodiments, from reading this description those of skill in the art may appreciate changes and modification that may be made which do not depart from the scope and spirit of the invention as described above and claimed hereafter.

We claim:

1. A method for improving the completion rate of a court ordered payment plans comprising the steps of:
establishing a plan to be overseen by a court or other judicial or quasi-judicial body, where the plan includes:
a clearly identifiable payor and at least one clearly identifiable payee;
a debt amount to be covered by the plan;
a term in month for paying the debt amount; and
a schedule of debt payments designed to repay the debt amount during the term;
coupling an insurance product with the plan, where the product includes:
a life insurance component, which provides funds in case of a payor's death during the term of the plan to repay an outstanding debt amount;
a disability component, which provided funds in case of a payor's disability during the term of the plan to repay an outstanding debt amount;
an unemployment component, which provided funds in case of a payor's unemployment during the term of the plan to repay an outstanding debt amount; and
a premium.

2. The method of claim 1, further comprising the step of:
terminating the insurance product, when the plan is complete.

3. The method of claim 1, wherein the unemployment component activates only if the payor becomes unemployed through no fault of the payor during the term of the plan.

4. The method of claim 1, wherein the product further includes a creditor bundling provision, where benefits under the insurance components are paid directly to a person or agency overseeing the plan to ensure that proceeds of each component are disbursed to all qualified creditors of the payor.

5. The method of claim 1, wherein the premium comprise a single product payment or a plurality of product payments having the same or different product payment amount during the term of the plan.

6. The method of claim 5, wherein the product payments comprise equal monthly payments.,

7. The method of claim 5, wherein the product payments start at an initial amount and decrease at a rate proportional to the outstanding debt amount.

8. The method of claim 5, wherein the product payments start at an initial amount and increase at a rate proportional to the outstanding debt amount.

9. A method for improving the completion rate of Chapter 13 Bankruptcy Reorganization Plan comprising the steps of:
establishing a Chapter 13 Bankruptcy Reorganization Plan including:
a clearly identifiable debtor and at least one clearly identifiable creditor;
a debt amount to be covered by the plan;
a term in months for repaying the debt amount; and
a schedule of debt payments designed to repay the debt amount during the term;
issuing an insurance product with the plan, where the product includes:
a life insurance component, which provides funds in case of a debtor's death during the term of the plan to repay an outstanding debt amount;
a disability component, which provided funds in case of a debtor's disability during the term of the plan to repay an outstanding debt amount;
an unemployment component, which provided funds in case of a debtor's unemployment during the term of the plan to repay an outstanding debt amount; and
a premium; and
terminating the insurance product, when the plan is complete.

10. The method of claim 9, wherein the unemployment component activates only if the debtor becomes unemployed through no fault of the debtor during the term of the plan.

11. The method of claim 9, wherein the product further includes a creditor bundling provision, where benefits under the insurance components are paid directly to a person overseeing the plan to ensure that proceeds of each component are disbursed to all qualified creditors of the debtor.

12. The method of claim 9, wherein the premium comprise a single product payment or a plurality of product payments having the same or different product payment amount during the term of the plan.

13. The method of claim 12, wherein the product payments comprise equal monthly payments.,

14. The method of claim 12, wherein the product payments start at an initial amount and decrease at a rate proportional to the outstanding debt amount.

15. The method of claim 12, wherein the product payments start at an initial amount and increase at a rate proportional to the outstanding debt amount.

16. A method for completing a Chapter 13 Reorganization Plan comprising the steps of:
establishing a Chapter 13 Reorganization Plan including:
a clearly identifiable debtor and at least one clearly identifiable creditor;
a total amount of debt covered by the plan,
a term in months for repaying the debt amount; and
a schedule of debt payments designed to repay the debt amount during the term;
issuing an insurance product including:
a life insurance component;
a disability component;
an unemployment component; and
a premium;
activating the life insurance component of the product, if the debtor dies during the term of the plan;
activating the unemployment component of the product, if the debtor becomes unemployed during the term of the plan, until the debtor becomes re-employed and able to resume plan payments or the plan is completed;
activating the disability component of the product, if the debtor becomes disabled during the term of the plan until the debtor becomes enabled, re-employed and able to resume plan payments or the plan is completed; and
terminating the product, if and when the plan is completed.

17. The method of claim 16, wherein the unemployment component activates only if the debtor becomes unemployed through no fault of the debtor.

18. The method of claim 16, wherein the product also includes a creditor bundling provision designed to insure that proceeds of the product are used as if the payment was coming directly from the debtor.

19. The method of claim 9, wherein the premium comprise a single product payment or a plurality of product payments having the same or different product payment amount during the term of the plan.

20. The method of claim 12, wherein the product payments comprise equal monthly payments.,

21. The method of claim 12, wherein the product payments start at an initial amount and decrease at a rate proportional to the outstanding debt amount.

22. The method of claim 12, wherein the product payments start at an initial amount and increase at a rate proportional to the outstanding debt amount.

23. An insurance system for improving the completion of Chapter 13 Bankruptcy Reorganization Plan comprising a chapter 13 reorganization plan including a total indebtedness, a term for repayment and a schedule of periodic payments and an insurance product including a life insurance component, a disability component and an unemployment component and a provision for creditor bundling so that funds from the insurance product once activated are distributed according to the Chapter 13 Bankruptcy Reorganization Plan.
